(19) United States
(12) Patent Application Publication
(10) Pub. No.: US 2012/0251005 A1
(43) Pub. Date: Oct. 4, 2012

(54) CHARACTER STRING INPUT DEVICE AND RECORDING MEDIUM

(75) Inventor: Yojiro Tonouchi, Inagi-shi (JP)

(73) Assignee: KABUSHIKI KAISHA TOSHIBA

(21) Appl. No.: 13/241,499

(22) Filed: Sep. 23, 2011

(30) Foreign Application Priority Data
Sep. 27, 2010 (JP) 2010-215894

(51) Int. Cl. G06K 9/62

(52) U.S. Cl. 382/187

(57) ABSTRACT

According to one embodiment, there is provided a character string input device. The device includes an input processing unit, a character string storage unit, an input prediction control unit, and an input prediction unit. The input processing unit inputs a character string with a character or a special code. The character string storage unit receives the character string with the character or the special code, adds the character to a stored character string, or updates the stored character string by the special code. The input prediction control unit controls a timing of extracting and sending at least part of the stored character string from the character string storage unit. The input prediction unit performs input prediction for the at least part of the stored character string output from the input prediction control unit and outputs a predicted character string.

### CROSS-REFERENCE TO RELATED APPLICATIONS

This application is based upon and claims the benefit of priority from prior Japanese Patent Application No. 2010-215894, filed Sep. 27, 2010, the entire contents of which are incorporated herein by reference.

### FIELD

Embodiments described herein relate generally to a character string input device for performing input prediction and a recording medium.

### BACKGROUND

Character string input for cellular phones and the like which are quickly widespread in recent years generally uses a method of combining prediction input and key input using a ten-key pad and several symbol keys. A method of inputting alphanumeric characters and 50 hiragana characters one by one using the ten-key pad is called “multi-tap”. The key input unit of a cellular phone or the like is provided with a ten-key numeric pad of “1”, “2”, . . . , “0” and function input keys. The key input unit has a small area and a small number of keys. For this reason, a plurality of, about 17 characters in total, including hiragana and katakana characters and uppercase and lowercase alphabetic characters, are assigned to one key. To input characters, the user switches the input mode to a corresponding character input mode and repetitively presses a number key until a desired character to be input is displayed on the display unit. In such multi-tap character input, the character that is being input is updated every time the user presses the key. In the multi-tap character input, a character string is normally input in combination with prediction input. In this case, after inputting several leading characters of a character string by multi-tap, the user selects a desired character string to be input from candidate character strings found by input prediction processing. This input prediction processing is performed every time the user presses a key.

In handwriting input, the character that is being input is updated every time the user writes one stroke of a character. When combined with input prediction processing, the prediction processing is executed every time the user writes one stroke.

In both character input by multi-tap and character input by handwriting recognition, a character cannot be determined by one user action, and an undetermined character string is displayed as the input character string halfway through the input. The input prediction processing is executed every time the input character string is updated. Hence, the operability is preferably improved by avoiding unnecessary input prediction processing.

### BRIEF DESCRIPTION OF THE DRAWINGS

FIG. 1 is a block diagram of a character string input device according to the first embodiment;

FIG. 2 is a flowchart showing the processing procedure of an input prediction control unit;

FIG. 3 is a view showing a state in which a character string storage unit sends predicted key characters to an input prediction unit;

FIG. 4 is a view showing multi-tap and input prediction;

FIG. 5 is a timing chart when a delay occurs in prediction/conversion processing;

FIG. 6 is a timing chart when controlling the send timing to prediction/conversion processing;

FIG. 7 is a timing chart showing omission of prediction processing when performing timing control;

FIG. 8 is a block diagram of a character string input device according to the second embodiment;

FIG. 9 is a block diagram of a character string input device according to the third embodiment;

FIG. 10 is a view showing an undetermined character string in writing-box-free character recognition; and

FIG. 11 is a view showing an undetermined character string in overlapping character recognition.

### DETAILED DESCRIPTION

In general, according to one embodiment, there is provided a character string input device. The device includes an input processing unit, a character string storage unit, an input prediction control unit, and an input prediction unit. The input processing unit inputs a character string with a character or a special code. The character string storage unit receives the character string with the character or the special code, adds the character to a stored character string, or updates the stored character string by the special code. The input prediction control unit controls a timing of extracting and sending at least part of the stored character string from the character string storage unit. The input prediction unit performs input prediction for the at least part of the stored character string sent from the input prediction control unit and sends a predicted character string.

An embodiment will now be described with reference to the accompanying drawings. This embodiment is directed to a character string input device to be used as a handwriting input device or a character input device using a ten-key pad having an information processing function in a small electronic device such as a cellular phone or a portable information terminal.

### First Embodiment

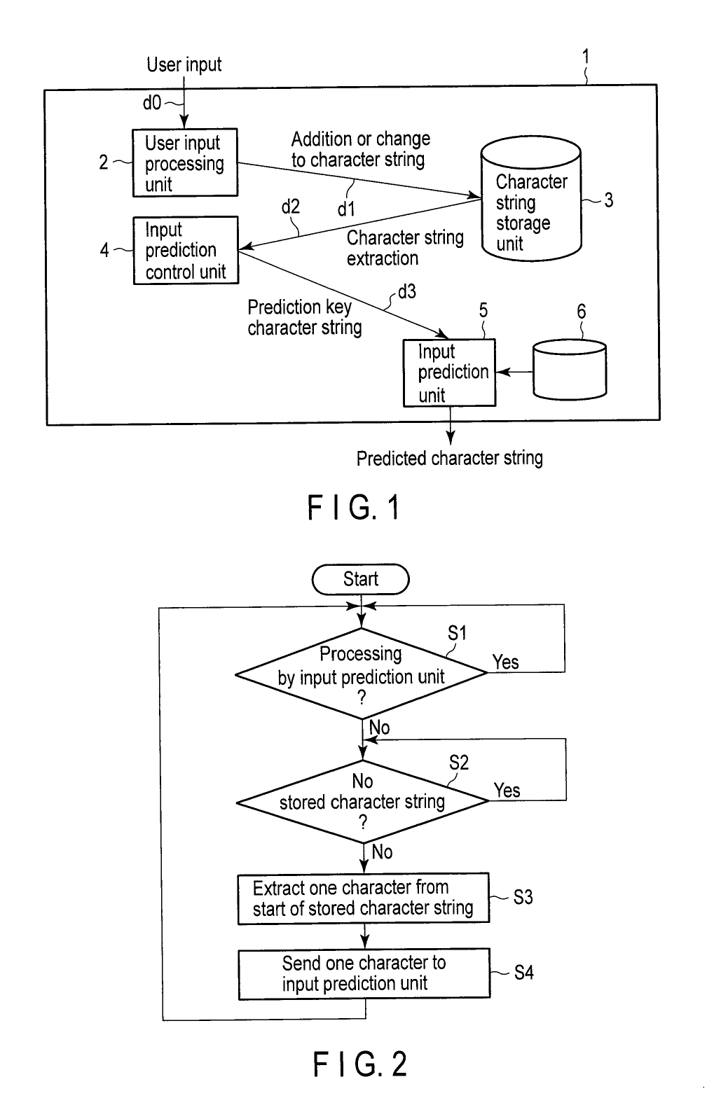

FIG. 1 is a block diagram of a character string input device according to the first embodiment. A character string input device 1 shown in FIG. 1 comprises a user input processing unit 2, a character string storage unit 3, an input prediction control unit 4, an input prediction unit 5, and a predictive character string dictionary 6. Note that a control unit configured to control the entire device and the like are not illustrated. The processing of this embodiment can be implemented by a program executable by a computer, and the program can be implemented as a computer-readable storage medium. Note that any storage medium such as a magnetic disk, a Floppy® disk, a hard disk, an optical disk (for example, CD-ROM, CD-R, DVD, or Blu-ray Disc), a magnetooptical disk (for example, MO), or a semiconductor memory is usable if it is capable of storing a program and readable by a computer or a built-in system, and any storage form is applicable. Alternatively, based on an instruction of the program installed from the storage medium to the computer or the built-in system, the OS (Operating System) running on the computer or MW (middleware) such as database management software or a network may execute part of each processing to implement the embodiment. The storage medium need not always be independent of the computer or the built-in system. Also included is a storage medium that stores or temporarily stores the program downloaded via a LAN, the Internet, or the like. The number of storage media is not limited to one. The storage medium also includes executing the processing of this embodiment from a plurality of media, and the media can have any format. Note that the computer or the built-in system executes each processing of this embodiment based on the program stored in the storage medium, and can be either a single device such as a personal computer or a microcomputer or a system formed by connecting a plurality of devices through a network. “Computer” is not limited to a personal computer but is a general term indicating a device or apparatus capable of implementing the above-described functions by a program, including an arithmetic processing device, a microcomputer, or the like included in an information processing device.

In this embodiment, multi-tap using a ten-key pad will be explained as a method of inputting characters from a user. However, an embodiment of a handwriting input device is also possible. In multi-tap, a plurality of kana characters are assigned to each number key, as shown in Table 1 below.

TABLE 1

| Number key | Hiragana characters |
|---|---|
| “1” | “ [symbol] ”, “ [symbol] ”, “ [symbol] ”, “ [symbol] ”, “ [symbol] ”, “ [symbol] ”, “ [symbol] ”, |
| | “ [symbol] ”, “ [symbol] ”, “ [symbol] ” |
| “2” | “ [symbol] ”, “ [symbol] ”, “ [symbol] ”, “ [symbol] ”, “ [symbol] ” |
| “3” | “ [symbol] ”, “ [symbol] ”, “ [symbol] ”, “ [symbol] ”, “ [symbol] ” |
| “4” | “ [symbol] ”, “ [symbol] ”, “ [symbol] ”, “ [symbol] ”, “ [symbol] ”, “ [symbol] ” |
| “5” | “ [symbol] ”, “ [symbol] ”, “ [symbol] ”, “ [symbol] ”, “ [symbol] ” |
| “6” | “ [symbol] ”, “ [symbol] ”, “ [symbol] ”, “ [symbol] ”, “ [symbol] ” |
| “7” | “ [symbol] ”, “ [symbol] ”, “ [symbol] ”, “ [symbol] ”, “ [symbol] ” |
| “8” | “ [symbol] ”, “ [symbol] ”, “ [symbol] ”, “ [symbol] ”, “ [symbol] ”, “ [symbol] ” |
| “9” | “ [symbol] ”, “ [symbol] ”, “ [symbol] ”, “ [symbol] ”, “ [symbol] ” |
| “0” | “ [symbol] ”, “ [symbol] ”, “ [symbol] ” |

Each number key is also assigned character types other than the kana characters. For example, the number key “6” is assigned not only hiragana characters “ [symbol] , [symbol] , [symbol] , [symbol] , [symbol] ” but also katakana characters “ [symbol] , [symbol] , [symbol] , [symbol] , [symbol] ”, uppercase alphabetic characters “M, N, O”, and lowercase alphabetic characters “m, n, o”.

The user input processing unit 2 outputs a character or a character string d1 being input in accordance with key input d0 from the user. For example, when inputting a character of the “ [symbol] ” column of the kana syllabary, the character d1 output from the user input processing unit 2 is updated as “ [symbol] ”″“ [symbol] ”→“ [symbol] ”→“ [symbol] ”→“ [symbol] ”→“ [symbol] ”→“ [symbol] ”→“ [symbol] ”→“ [symbol] ”→“ [symbol] ”→“ [symbol] ” . . . every time the user presses the number key “1” assigned the “ [symbol] ” column.

The character string storage unit 3 that stores a character string updates the stored character string based on the character or character string d1 output from the user input processing unit 2. At this time, the user input processing unit 2 instructs to add or update a character. When adding, a designated additional character or character string is added to the end of the stored character string. When updating, characters or character strings are erased in the designated number of characters from the end of the stored character string, and a designated additional character or character string is added.

In Table 2, the update instruction from the user input processing unit 2 is done using a character string including a special code. The number of special codes “BS” at the start of a character string is the number of characters to be erased. A character string other than “BS” is the character string to be added. If “BS” is included, update processing is performed. If “BS” is not included, addition processing is performed. Such update processing can be performed by the character string storage unit 3.

TABLE 2

| | Instruction | | |
|---|---|---|---|
| | from user | | |
| | input | | |
| | processing | Stored character string | |
| Processing contents | unit | Before update | After update |
| Addition | “ [symbol] ” | “ [symbol] ” | “ [symbol] ” |
| processing | | | |
| Update | “[BS] + [symbol] ” | “ [symbol] ” | “ [symbol] ” |
| processing | | | |

The input prediction control unit 4 extracts at least part d2 of the character string from the stored character string in the character string storage unit 3 and sends the character to the input prediction unit 5.

FIG. 2 is a flowchart illustrating an example of the processing procedure of the input prediction control unit. This processing procedure corresponds to a case in which the input prediction control unit extracts the character d2 one by one from the start of the character string storage unit 3 and sends the character to the input prediction unit 5. Another example of control using the character string storage unit 3 and the input prediction control unit 4 will be described later.

In step S1, the input prediction control unit determines whether the input prediction unit 5 is executing processing. Processing of the input prediction unit 5 is character string prediction processing for a key character string input up to the present point of time. Step S1 is repeated until the processing of the input prediction unit 5 ends. In other words, the input prediction control unit 4 waits until processing of the input prediction unit 5 transits to the idle state. In step S2, the input prediction control unit 4 determines whether a character or a character string is stored in the character string storage unit 3. If no character or character string is stored in the character string storage unit 3, the processing of step S2 is repeated. In other words, when no character or character string is stored in the character string storage unit 3, the input prediction control unit waits until a new character or character string is stored in the character string storage unit 3. In step S3, the input prediction control unit 4 extracts one character at the start of the stored character string in the character string storage unit 3. The input prediction control unit 4 sends this one extracted character to the input prediction unit 5 (step S4).

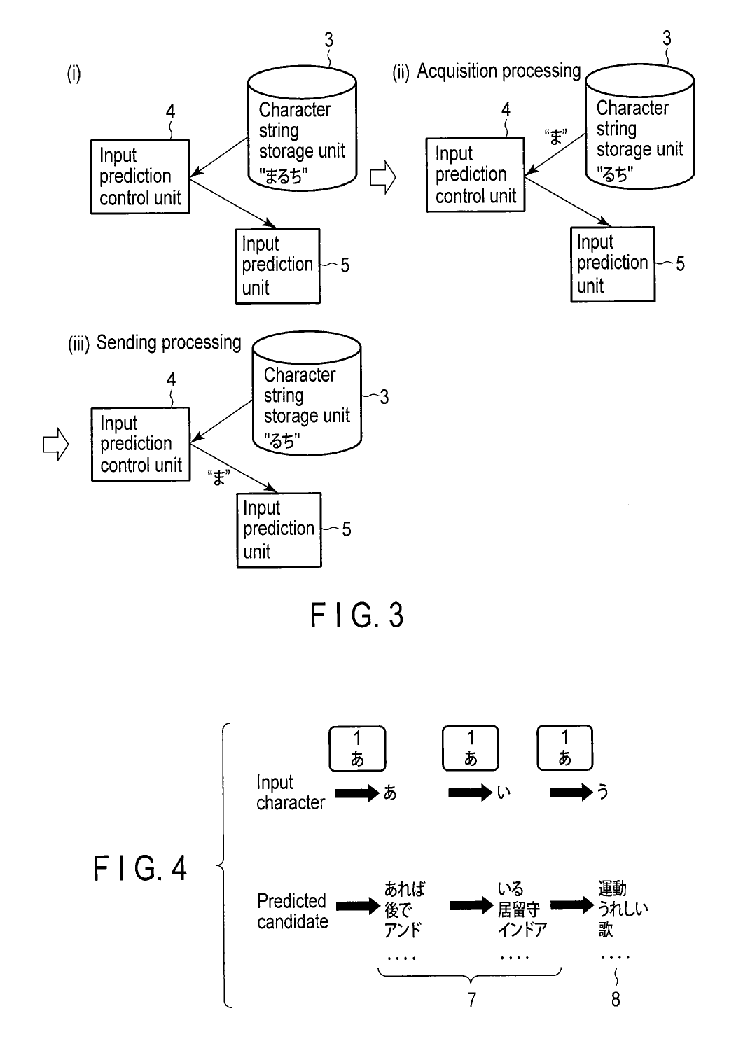

Regarding the above-described processing, FIG. 3 shows a state in which when, for example, a character string “ [symbol] ” is stored in the character string storage unit 3, the input prediction control unit 4 extracts the first character “ [symbol] ” of the character string from the character string storage unit 3 and sends it to the input prediction unit 5.

The input prediction unit 5 searches the predictive character string dictionary 6 using the character string supplied from the input prediction control unit 4 as a key character string, and outputs a partially matching predicted character string as a predicted candidate. As the predictive character string dictionary 6 used in multi-tap, for example, a database having a format as shown in Table 3 below may be used. In this case, the input prediction processing searches for characters whose reading from the start partially matches the key character, and outputs a corresponding predicted character string. For example, when the input key character string is “ [symbol] ”, “ [symbol] ” and “ [symbol] ” are output.

TABLE 3

| Reading | Predicted character string |
|---|---|
| “ [symbol] ” | “ [symbol] ” |
| “ [symbol] ” | “ [symbol] ” |
| “ [symbol] ” | “ [symbol] ” |
| “ [symbol] ” | “ [symbol] ” |
| “ [symbol] ” | “ [symbol] ” |
| . . . | . . . |

Control using the character string storage unit 3 and the input prediction control unit 4 will be described in detail.

In both character input by multi-tap and character input by handwriting recognition, a character cannot be determined by one user action, and an undetermined character string is displayed as the input character string halfway through the input. The one user action is a key operation in multi-tap character input or an operation of inputting one stroke of a character in handwriting recognition. For example, as shown in FIG. 4, to input a character “ [symbol] ” by multi-tap, the user needs to press the number key “1” three times. During this operation process, when an undetermined character “ [symbol] ” or “ [symbol] ” is given to the input prediction processing, an unnecessary prediction result 7 such as “ [symbol] ”, “ [symbol] ”, “ [symbol] ”, “ [symbol] ”, “ [symbol] ”, or “ [symbol] ” is displayed every time, as shown in FIG. 4. The prediction result 7 for the input character is updated and displayed every time the user presses a key or writes one stroke. It is annoying for the user.

Instead, it is preferable to input “ [symbol] ” as a determined character and quickly display a prediction result 8 such as “ [symbol] ”, “ [symbol] ”, or “ [symbol] ” for the input character. Conversely, the unnecessary prediction result 7 as shown in FIG. 4 may lead to overhead of calculation processing by the wasteful prediction processing and thus lead to a delay of the prediction processing. Accumulation of delays of the prediction processing also results in the lower response speed of the user interface for character input.

To prevent this, in this embodiment, the input prediction control unit 4 configured to control the prediction processing is provided to control the timing of sending a prediction key character string d3 to the input prediction unit 5 based on the character input condition or the processing condition of the input prediction unit 5.

For example, as is apparent from FIG. 5, prediction/conversion for “ [symbol] ” is performed, and prediction/conversion or “BS” is performed. Then, input processing of “BS+ [symbol] ” is performed by multi-tap, as indicated by a dotted line 9, before prediction/conversion for “ [symbol] ”. This indicates that if delays of the prediction processing accumulate, change of an undetermined character may be found before the undetermined character stored in the buffer of prediction processing is actually given to the prediction processing. Note that Lg1 represents a time lag from input of “ [symbol] ” to display of the prediction result.

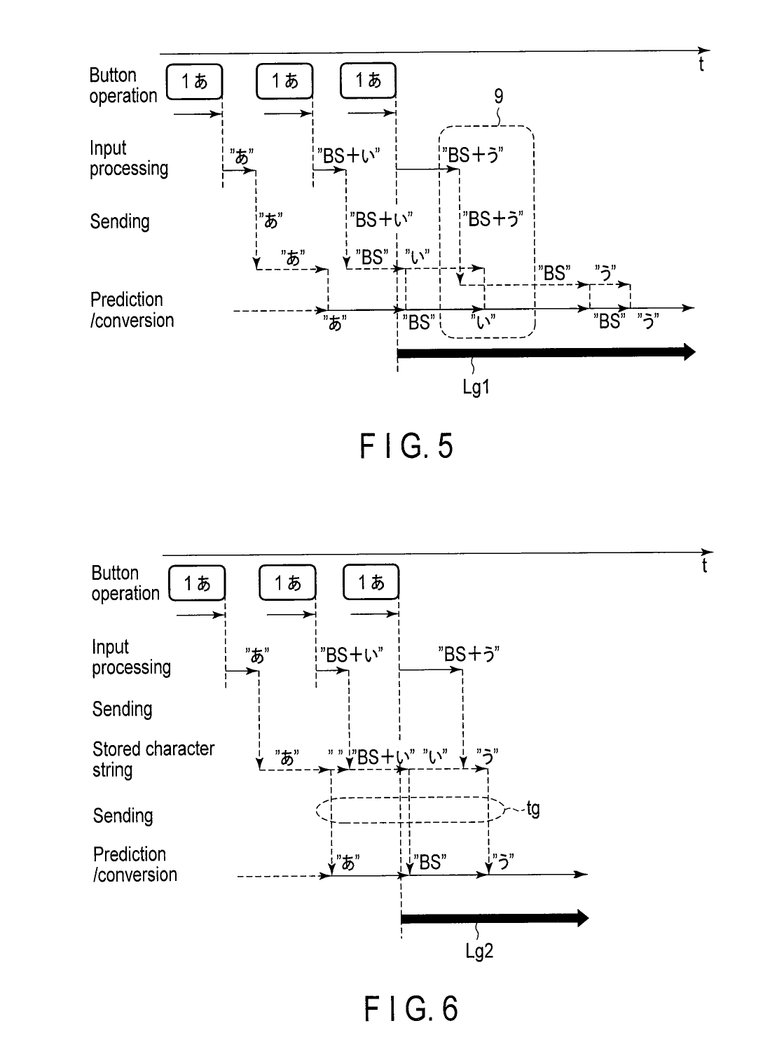

If timing control by the input prediction control unit 4 is not performed, “ [symbol] ” is directly provided for prediction processing. After that, prediction processing of “ [symbol] ” is canceled by “BS”. Finally, prediction processing of “ [symbol] ” is performed. In this embodiment, however, the input prediction control unit 4 controls a timing tg of sending a character or a character string stored in the character string storage unit 3 to the input prediction unit 5, as shown in FIG. 6.

As a result, if timing control is not performed, unnecessary processes such as prediction processing of “ [symbol] ” and cancel processing of “ [symbol] ” occur. In this embodiment, however, prediction processing of “ [symbol] ” can quickly be performed while avoiding the unnecessary processes. It is therefore possible to make a time lag Lg2 from input of “ [symbol] ” to display of the prediction result shorter than the above-described time lag Lg1.

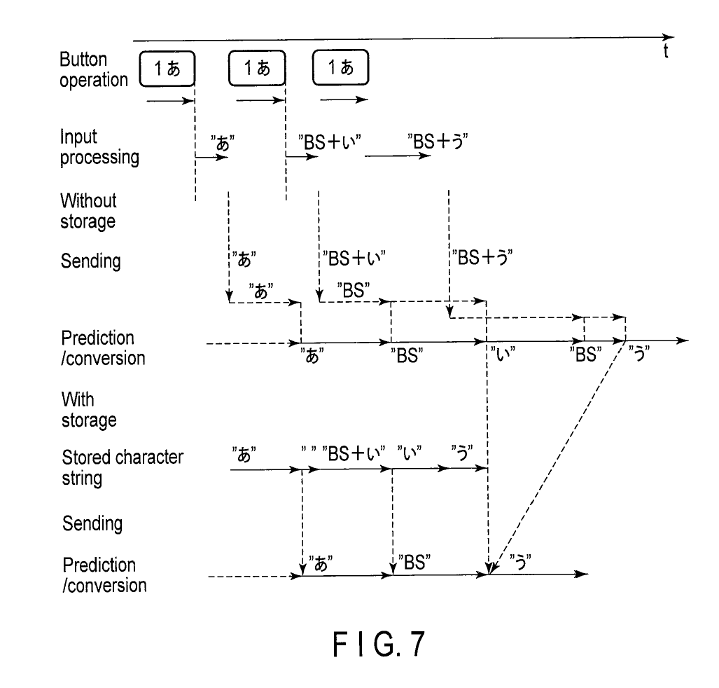

The gist of timing control by the input prediction control unit 4 according to this embodiment is that an undetermined character likely to be changed is sent to the input prediction unit 5 after delayed as much as possible so that the character is not changed after sending. For this purpose, the device 1 comprises the character string storage unit 3. As shown in FIG. 7, the character string stored in the character string storage unit 3 changes a “ [symbol] ”, “(null character)”, “ [symbol] ”, “ [symbol] ”, and “ [symbol] ”. The character string storage unit 3 can absorb “ [symbol] ” and “BS” of “ [symbol] ” and “BS+ [symbol] ”. Hence, prediction processing of “ [symbol] ” and “BS” can be omitted.

Note that the timing of sending a character or a character string to the input prediction unit 5 can be controlled in several ways.

For example, (i) as shown in the flowchart of FIG. 2, characters are acquired one by one from the start of the character string stored in the character string storage unit 3 and sent.

(ii) If the number of characters of the stored character string is (N+1) or more (N≧1), a character string excluding N characters from the end of the stored character string is acquired and sent. If the number of characters is N or less, characters are acquired one by one from the start of the stored character string and sent. N is preferably the maximum number of characters of an undetermined character string. For example, in multi-tap or character recognition with writing-boxes, the maximum number of characters of an undetermined character string is 1. Hence, N is 1.

Character recognition with writing-boxes is a method of character recognition. In this technique, the user inputs characters in a predetermined frame one by one for character recognition. In this case, the frame designates the ranges to separate characters from each other. On the other hand, to recognize characters without separating them from each other, writing-box-free character recognition or overlapping character recognition is used. Overlapping character recognition is used when writing characters in a predetermined place without separating them from each other.

In the method (ii), processing is performed assuming that an undetermined character string almost has a fixed length. However, this method is not optimum when outputting a character string having an indefinite length as a recognition result as in writing-box-free character recognition or overlapping character recognition because the number of undetermined characters is not constant. For example, if a recognition result character string can be separated into a determined character string and an undetermined character string, as in overlapping character recognition, control can be done based on the information in the following way.

(iii) When the stored character string includes determined character strings, all the determined character strings of the stored character string are acquired and sent. If the stored character string includes no determined character strings but only undetermined character strings, the characters are sequentially sent one by one from the start of the undetermined character strings.

In the methods (i), (ii) and (iii), when sequentially sending characters one by one, the time interval is controlled, for example, in the following way.

(iv) When sequentially sending characters one by one, the characters are sent at regular intervals based on a predetermined time interval.

### Second Embodiment

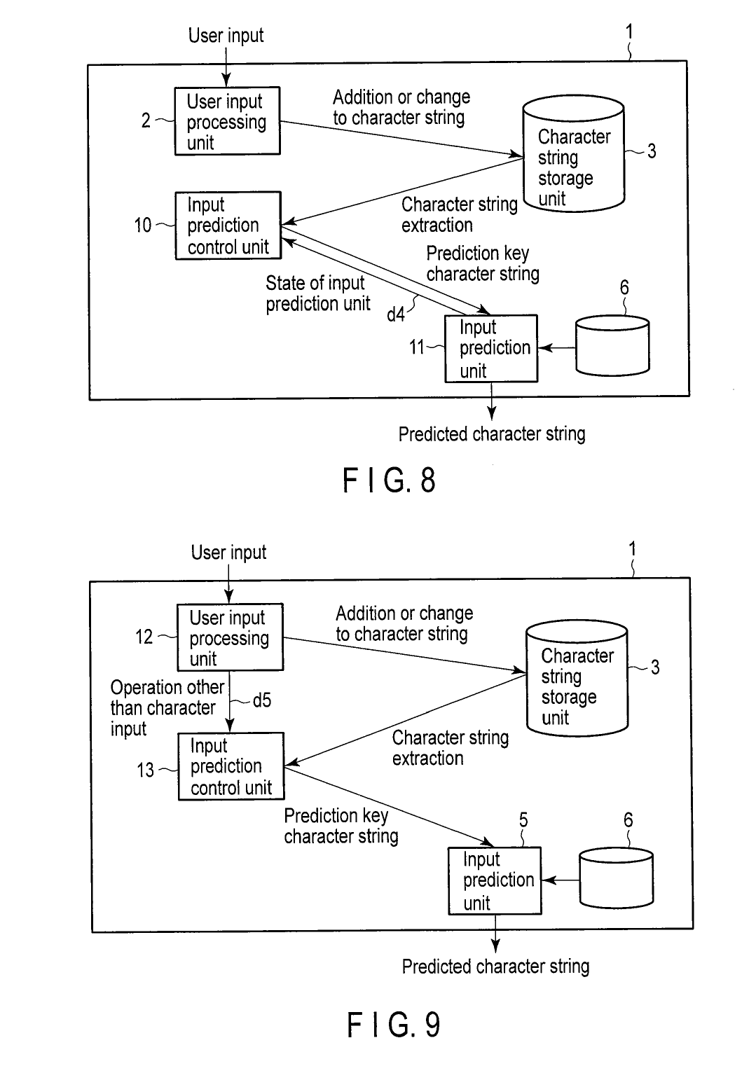

FIG. 8 is a block diagram of a character string input device according to the second embodiment. In the first embodiment, control is performed based on the information of the stored character string in the character string storage unit 3. Using information from another processing unit enables more efficient control. In the second embodiment, an input prediction control unit 10 performs input prediction control by confirming the processing state of an input prediction unit 11. In the second embodiment, a signal d4 representing the state of the input prediction unit 11 is appropriately given to the input prediction control unit 10. The input prediction control unit 10 determines based on the signal d4 whether the input prediction unit 11 is executing input prediction processing. If the input prediction unit 11 is executing input prediction processing, sending to the input prediction unit 11 is not performed.

### Third Embodiment

FIG. 9 is a block diagram of a character string input device according to the third embodiment. In the third embodiment, when the user has performed an operation other than character input, a user input processing unit 12 inputs an edit command d5 to an input prediction control unit 13 to execute processing.

When user performs an input operation other than character input, the character string being input may be regarded as determined. In many cases, a determination operation, deletion of one character, or cursor move can be executed by, for example, assigning the operation to a specific key of a ten-key pad or assigning the operation to a gesture in handwriting recognition. In this case, the input prediction control unit 13 accepts the edit command d5 for the user operation (for example, determination operation, character deletion, or cursor move) other than character input. The input prediction control unit 13 thus determines that the user has performed the operation other than character input, regards the character string input so far as determined, and sends all stored character strings in a character string storage unit 3 to an input prediction unit 5.

Alternatively, the input prediction control unit 13 determines based on the edit command d5 that change processing in the character string storage unit 3 is change processing for the character string that is being processed by the input prediction unit 5. In this case, the input prediction control unit 13 may control the input prediction unit 5 to cancel prediction processing in progress.

According to the above-described embodiments, the number of times of input prediction processing can be decreased, and further delay occurrence can be prevented. This allows to improve the speed of response to the user and also reduce power consumption by decreasing the calculation amount. Additionally, in a character string input device that combines the input prediction method and the character input method that does not determine a character by one action, like character input using a ten-key pad provided in a cellular phone or the like, the number of times of wasteful input prediction processing can be decreased, and the speed of response to the user can be improved. It is therefore possible to improve the operability by avoiding unnecessary input prediction processing.

Note that various control methods in the input prediction control unit have been described. Each method may be used independently, or a plurality of methods may be combined. The user input processing unit has been described by exemplifying character input based on multi-tap of a ten-key pad. However, the method is not limited to multi-tap. For example, the character input can also be implemented by performing a plurality of actions to input characters so that the input character changes in every action. The character input can also be implemented by handwriting recognition. In character input by handwriting recognition, every time the user writes one stroke of a character, character recognition processing is performed, and the result is updated.

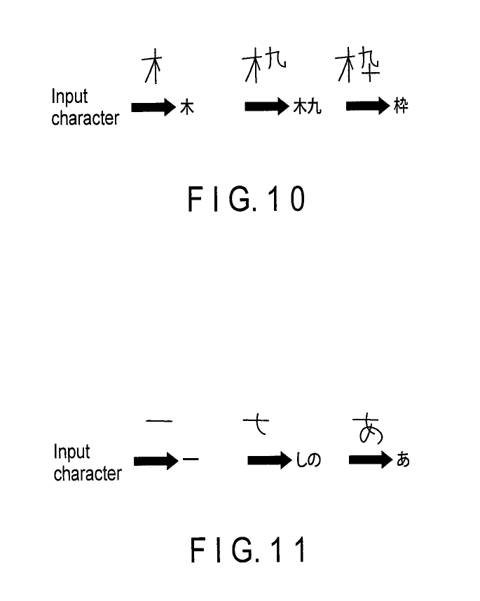

FIG. 10 illustrates an example of an undetermined character string in writing-box-free character recognition. For example, when writing a character “ [symbol] ”, an undetermined character string having an indefinite length such as “ [symbol] ” or “ [symbol] ” is output during the process. FIG. 11 illustrates an example of an undetermined character string in overlapping character recognition. For example, when writing “ [symbol] ” an undetermined character string having an indefinite length such as “ [symbol] ” or “ [symbol] ” is output during the process. In the writing-box-free character recognition or overlapping character recognition as well, unnecessary prediction processing can be avoided by controlling the timing of sending a prediction key character string to the input prediction unit in accordance with the above-described first to third embodiments.

In addition, controlling the timing of sending a character string to the input prediction unit makes it possible to reduce unnecessary processing even an in information search on a database using an text or a code. For example, the search on the database may be a search on a network system by the Internet or the like. For example, the Internet provides a variety of search sites which predict a keyword upon a search. Controlling the timing of sending a character string to the input prediction unit allows to reduce unnecessary processing concerning keyword prediction upon a search.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A character string input device comprising:
an input processing unit configured to input a character string with a character or a special code;
a character string storage unit configured to receive the character string with the character or the special code, add the character to a stored character string, or update the stored character string by the special code;
an input prediction control unit configured to control a timing of extracting and sending at least part of the stored character string from the character string storage unit; and
an input prediction unit configured to perform input prediction for the at least part of the stored character string sent from the input prediction control unit and output a predicted character string.

2. The device according to claim 1, wherein the input prediction control unit controls the timing by prohibiting the at least part of the stored character string from being sent to the input prediction unit during a period the input prediction unit is performing the input prediction.

3. The device according to claim 1, wherein the input prediction control unit controls the timing by extracting each character from a start of the stored character string and sending the character string to the input prediction unit.

4. The device according to claim 1, wherein the input prediction control unit controls the timing by, when the number of characters of the stored character string stored in the character string storage unit is not less than (N+1) (N≧1), sending a character string excluding N characters at an end of the stored character string to the input prediction unit, and when the number of characters is not more than N, extracting the characters one by one from a start of the stored character string and sending the characters to the input prediction unit.

5. The device according to claim 1, wherein
the character string storage unit stores the stored character string while distinguishing between a determined character string and an undetermined character string, and
the input prediction control unit controls the timing by directly sending the determined character string stored in the character string storage unit to the input prediction unit and extracting the characters one by one from a start of the undetermined character string and sending the characters to the input prediction unit.

6. The device according to claim 1, wherein when the input prediction unit has accepted an edit command, the input prediction control unit sends all stored character strings up to acceptance of the edit command to the input prediction unit.

7. The device according to claim 6, wherein the edit command is a command of at least one of a character determination operation, a character erase operation, and cursor move.

8. The device according to claim 3, wherein the input prediction control unit sends at least part of the stored character string extracted from the character string storage unit to the input prediction unit at a preset time interval.

9. The device according to claim 1, wherein when it is found that a prediction key character string that is being processed by the input prediction unit is to change, the input prediction control unit controls the input prediction unit to cancel input prediction processing for the prediction key character string.

10. A non-transitory computer-readable recording medium which records a program comprising:
inputting a character string with a character or a special code;
storing the character string with the character or the special code in a character string storage unit, adding the character to a stored character string, or updating the stored character string by the special code;
controlling a timing of extracting and sending at least part of the stored character string from the character string storage unit; and
performing input prediction for the at least part of the stored character string sent in accordance with the timing and sending a predicted character string.
